(19) United States
(12) Patent Application Publication
(10) Pub. No.: US 2020/0410576 A1
(43) Pub. Date: Dec. 31, 2020

(54) Systems and Methods for Implementing an Interactive Virtual Design Tool

(71) Applicant: Paul R. Salmonson, Scottsdale, AZ (US)

(72) Inventor: Paul R. Salmonson, Scottsdale, AZ (US)

(21) Appl. No.: 16/915,597

(22) Filed: Jun. 29, 2020

Related U.S. Application Data
(60) Provisional application No. 62/867,722, filed on Jun. 27, 2019.

(51) Int. Cl. G06Q 30/06; G06T 19/00

(52) U.S. Cl. CPC G06Q 30/0643; G06T 19/00; G06F 3/0482; G06T 2210/04; G06Q 30/0633

(57) ABSTRACT

A virtual, interactive floorplan system includes a database system configured to store data associated with a plurality of home interior options, and a web-based portal communicatively coupled to the database system, wherein the web-based portal is configured to provide a user interface. The user interface provides: (a) an option-selection mechanism through which a user can select, for a specified home design, one or more options from the plurality of home interior options; (b) a graphical visualization of the specified home design from a 2D plan view and a 3D virtual interactive mode that together display the effect of selecting the home interior options; (c) a report generation mechanism through which the user can generate purchase orders and trade specific installation instructions in the form of at least lot-specific plans, orders, and a bill of materials.

### CROSS-REFERENCE TO RELATED APPLICATIONS

This application claims priority to U.S. Provisional Patent Application Ser. No. 62/867,722, filed Jun. 27, 2019, the entire contents of which are hereby incorporated by reference.

### TECHNICAL FIELD

The present invention generally relates to the design of residential and commercial interior spaces. In particular, the present invention relates to the visualization, planning, and purchasing of electrical, lighting, and other home technology options.

### BACKGROUND

The task of designing, selecting, and installing electrical and lighting features within a new home has traditionally been a difficult task, involving a number of different parties—e.g., home buyers, designers, home builders, and tradesmen. Currently known systems for selecting and installing such options are unsatisfactory in a number of respects.

For example, prior art interactive floorplan systems generally allow only limited 3D visualization of the interior, and do not provide a way for the designer or homeowner to visualize, in real time, the visual effect of a particular option selection. Furthermore, such systems are not linked to a kit/parts supply chain in a manner that allows both retail and wholesale pricing, P.O.'s, and bills-of-material to be generated quickly and in a way that is responsive to changes made by the parties. As a result, such systems are prone to errors, leading to increased costs and construction cycle-times.

Accordingly, systems and methods are needed that overcome these and other limitations of prior art interactive floorplan systems.

### BRIEF SUMMARY

Various embodiments of the present invention relate to systems and methods for a virtual, interactive floorplan system that is integrated into a supply chain, thereby allowing designers, homeowners, builders, and installers to efficiently specify electrical, lighting, and other home technology items in a manner that reduces construction cycle-time and field errors. In accordance with various embodiments, the web-based portals and user interfaces are branded within the home builders' website and options-selection systems. The interactive floorplan system allows the homeowner to visualize the home not only in a top-down 2D mode, but also in a 3D virtual, interactive mode in which the homeowner can dynamically visualize the aesthetic and illumination effects of a variety of different lighting options. The tool also generates purchase orders and trade-specific installation instructions in the form of lot-specific plans, orders, and bills of materials for use by the builder and the installing trades.

### BRIEF DESCRIPTION OF THE DRAWING FIGURES

The present invention will hereinafter be described in conjunction with the appended drawing figures, wherein like numerals denote like elements, and:

FIG. 1 is a general block diagram illustrating a virtual interactive design tool in accordance with various embodiments;

FIG. 2 is a flowchart illustrating an interactive design method in accordance with various embodiments;

FIG. 3 illustrates an example floorplan useful in describing the present invention;

FIG. 4 is a virtual rendering of a portion of the floorplan illustrated in FIG. 3;

FIGS. 5A-5F illustrate various user interface components of an admin interface in accordance with various embodiments;

FIGS. 6A-6D illustrate various user interface components of a trades/builder admin interface in accordance with various embodiments;

FIGS. 7A-7B illustrate various user interface components of a builder interface in accordance with various embodiments;

FIGS. 8A-8B illustrate various user interface components of a client/homeowner interface in accordance with various embodiments; and

FIGS. 9A-9B illustrate various user interface components of a trades interface in accordance with various embodiments.

### DETAILED DESCRIPTION OF PREFERRED EXEMPLARY EMBODIMENTS

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to an improved, web-based interactive design tool for lighting, electrical, and other home technology options.

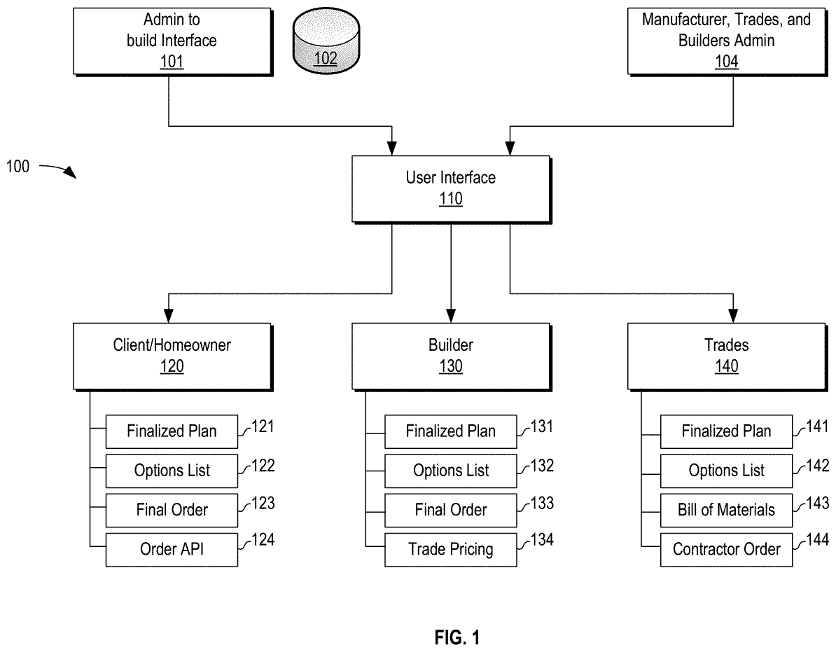

Referring now to the general block diagram of FIG. 1, a virtual interactive design tool system (“design tool,” or simply “system”) 100 in accordance with various embodiments generally includes an admin interface 101, a datastore and/or database system 102, and a manufacturer, trades, and builders admin interface (“builders admin interface”) 104, all of which may be employed to provide a web-based user interface 110. As shown, user interface 110 can be accessed by multiple parties, and provides appropriate access and functionality depending upon that party's role.

For example, a client/homeowner (or simply “client”) 120 can access user interface 110 in order to interact with and review: a finalized plan 121, an options list 122, a final order 123, and an order API 124. Similarly, a builder 130 can access user interface 110 in order to interact with and review: a finalized plan 131, an options list 132, a final order 133, and trade pricing 134. Finally, a trades entity can access user interface 110 to interface with and review: a finalized plan 141, an options list 142, a bill of materials 143, and a contractor order 143. In accordance with various embodiments, options list 122, 132, and 142 may be substantially identical (though they may be formatted differently depending upon the accessing party). Similarly, finalized plan 121, 131, and 141 may also be substantially identical, as well as options list 122 and 132.

It will be understood that the system of FIG. 1 will generally include various servers, processors, routers, web services, database software, and other such components well known in the art. In the interest of simplicity, such components are not illustrated in FIG. 1.

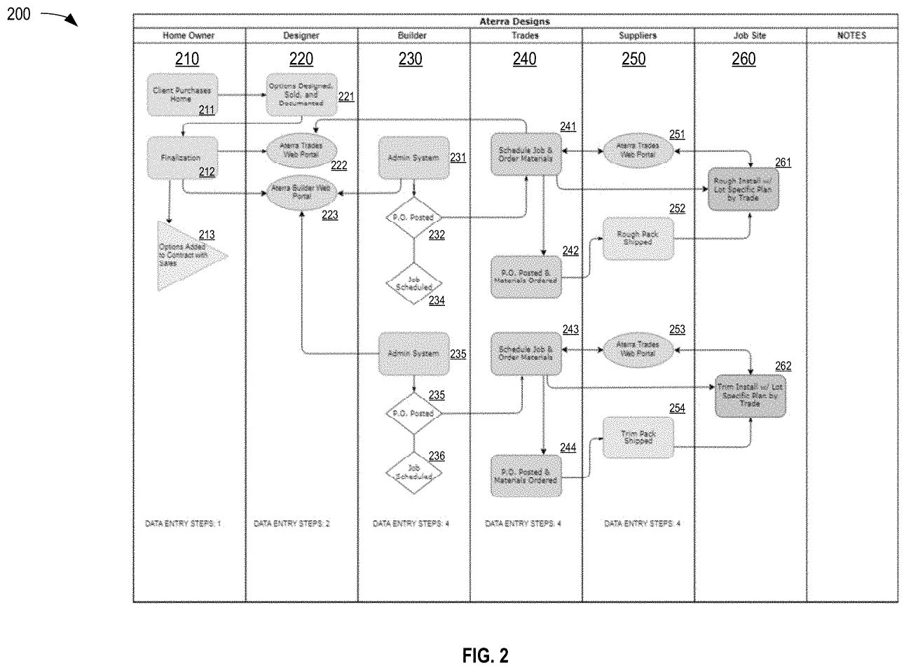

FIG. 2 is a flowchart illustrating an interactive design method 200 in accordance with various embodiments. In this example, six entities take part in the design and construction process: home owner (or “client”) 210, designer 220, builder 230, trades 240, suppliers 250, and job site 260. Initially, at 211, the client purchases a home. Subsequently, at 221, options are designed, sold, and documented by designer 220. Home owner 210 then finalizes the plan (at 212), and the finalized plan is then propagated to the trades web portal (222) and builder web portal (223). These web portals will generally be implemented by the user interface 110 shown in FIG. 1.

Builder 230, trades 240, suppliers 250, and job site 260 then interact with the portals in two parallel paths as illustrated in FIG. 2: one dealing with rough install (culminating in rough install with a lot-specific plan by trade 261) and trim install (culminating in trim install with a lot-specific plan by trades, 262). To accomplish these tasks, the various entities interact with, respectively: admin system 231, which posts the relevant purchase order (232) and indicates that the job has been scheduled (234); and admin system 235, which similarly posts the P.O. (235) and indicates that the trim-related job has been scheduled (236).

With respect to rough install, the process includes the trades scheduling the job and ordering material (241), posting the P.O and ordered materials (242), rough pack shipping by suppliers 250 (252), and job site 260 interacting with trades web portal 251. With respect to trim install, the process includes the trades scheduling the job and ordering material (243), posting the P.O and ordered materials (244), trim pack shipping by suppliers 250 (254), and job site 260 interacting with trades web portal 253 (262). As shown at the bottom of FIG. 2, the number of data entry steps vary depending upon the entity; i.e., one data entry step by home owner 210, two for designer 220, four for builder 240, and four for suppliers 250.

As mentioned previously, one benefit of the present system involves allowing the designer, homeowner, or other party to interactively and quickly visualize how changes to the lighting and/or other electrical features will impact the appearance of the home's interior.

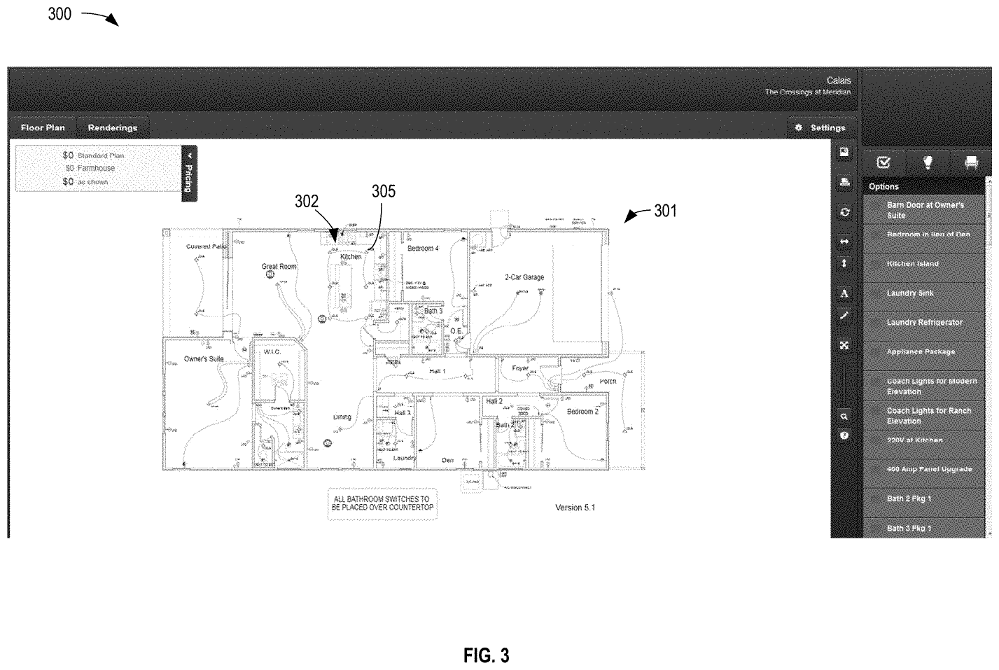

FIG. 3, for example, illustrates an example floorplan useful in describing the present invention. At the top, there are two tabs: “Floor Plan” and “Renderings.” As shown in the Floor Plan mode, the floorplan includes a kitchen area 302. On the right side of the user interface 300 (110 in FIG. 1), the designer is provided with a variety of lighting, electrical, and other options that can be selected (e.g., “coach lights for modern elevation”, etc.). As the options are selected, the floorplan 301 changes in real time to reflect those changes. For example, the floorplan includes a number of ceiling mounted lights 305. As will be described below, the various layers of floorplan 301 are associated with individual “SVG nodes” or “Layer IDs,” which provide a unique scheme for organizing the various kits/parts that compose each option that pull pricing and parts information from 101 and 104 of FIG. 1.

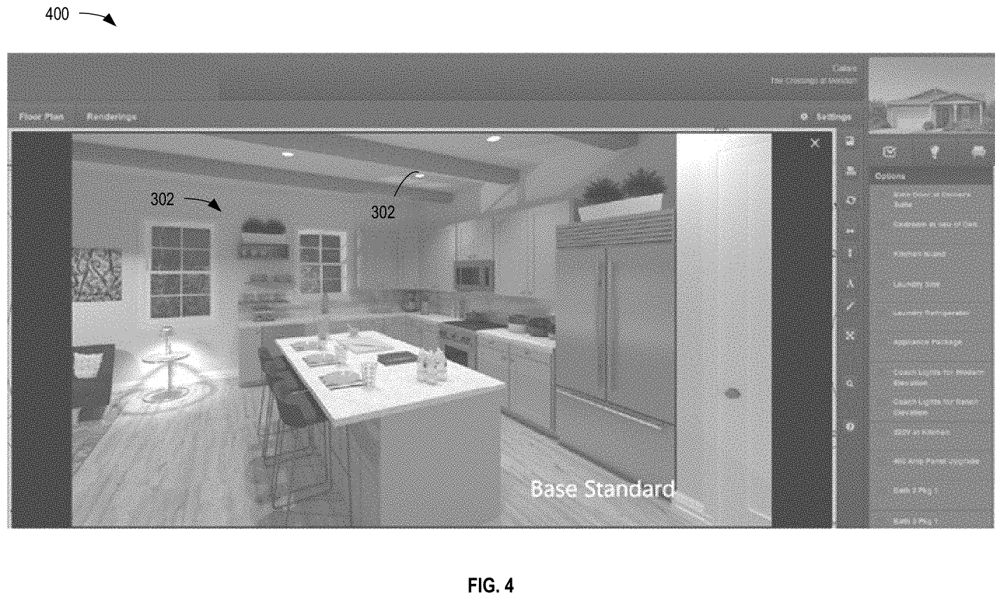

FIG. 4 is a virtual 3D rendering 400 of a portion of the floorplan illustrated in FIG. 3 (i.e., after selecting the Renderings tab shown in FIG. 3). The resulting image shows the kitchen area 302 with the ceiling lights illuminated, allowing the homeowner and/or designer to quickly visualize the aesthetic effect of various lighting options. In some embodiments, the user interface can be manipulated (e.g., via a mouse, keyboard, or other input device) such that the field of view illustrated in FIG. 400 can be rotated sideways, up, down, etc. In some embodiments, virtual locations are selected from a discrete set of predetermined and pre-rendered locations within floorplan 301 (indicated by a camera icon in FIG. 3). In other embodiments, however, the user is allowed to “walk through” the floorplan 301, much in the same way a player might walk through a virtual world in an open-world video game, allowing the user to virtually picture the interior space (and in some cases the exterior of the structure) while virtually observing the result of the option choices. In some embodiments, the user may interact with light switches and other such electrical controls. In some embodiments, the user may employ virtual reality goggles to view the interior in a fully immersive manner. That is, the illustrated system may include suitable software for interfacing with a virtual reality and/or mixed reality headset using software techniques well known in the art.

While the user interfaces used in connection with the present invention may vary, and are not intended to be limiting, the figures that follow illustrate the various web-based windows and user interface components that the homeowner, builder, and trades may experience.

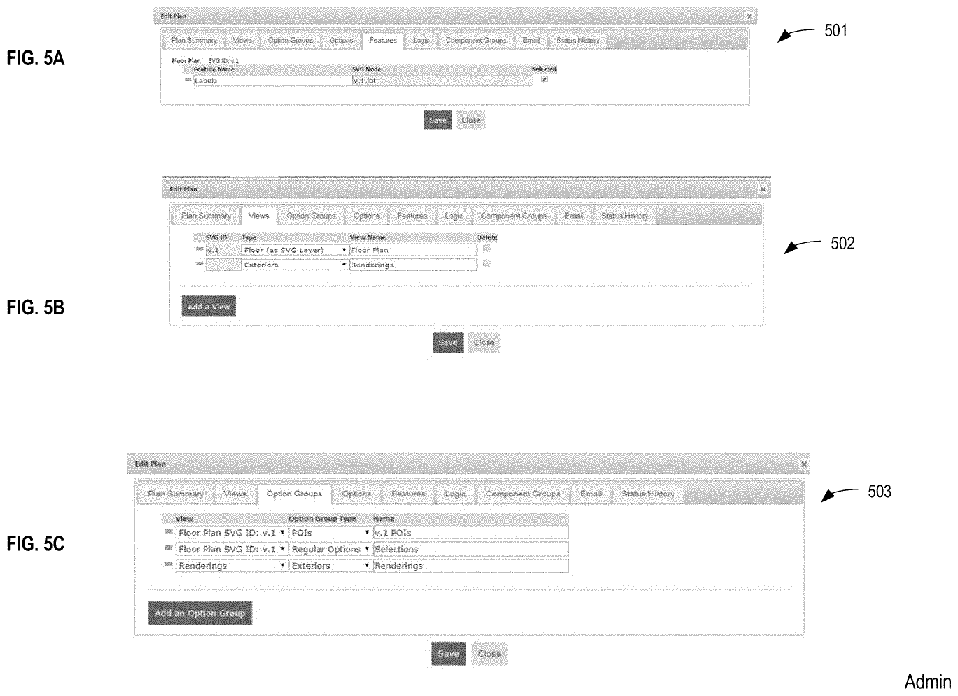

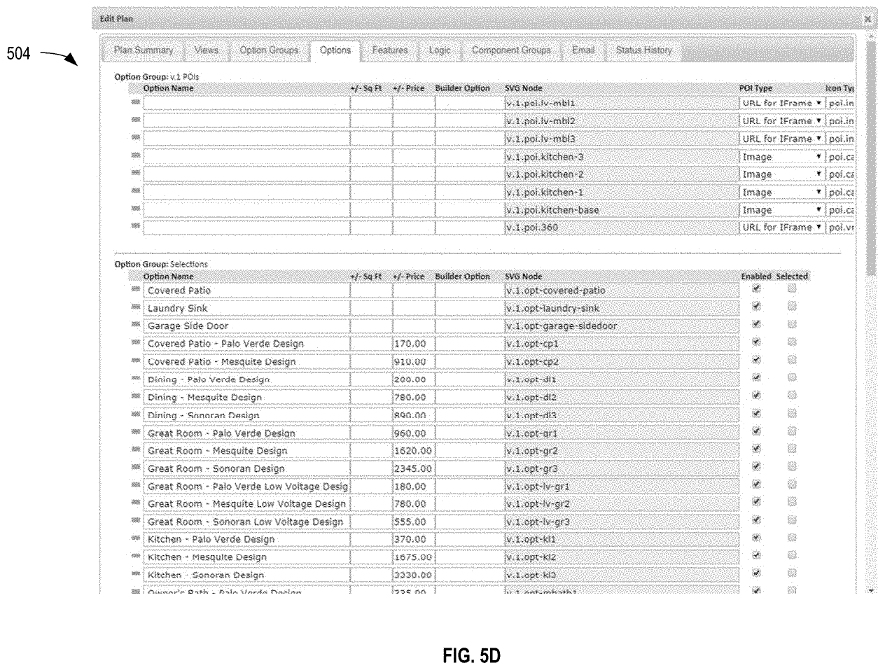

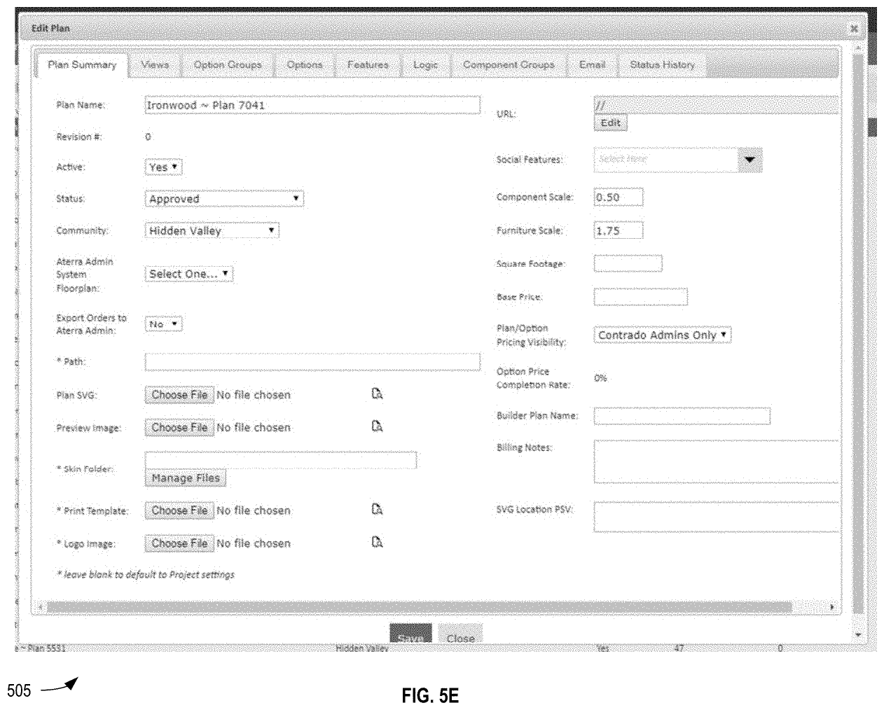

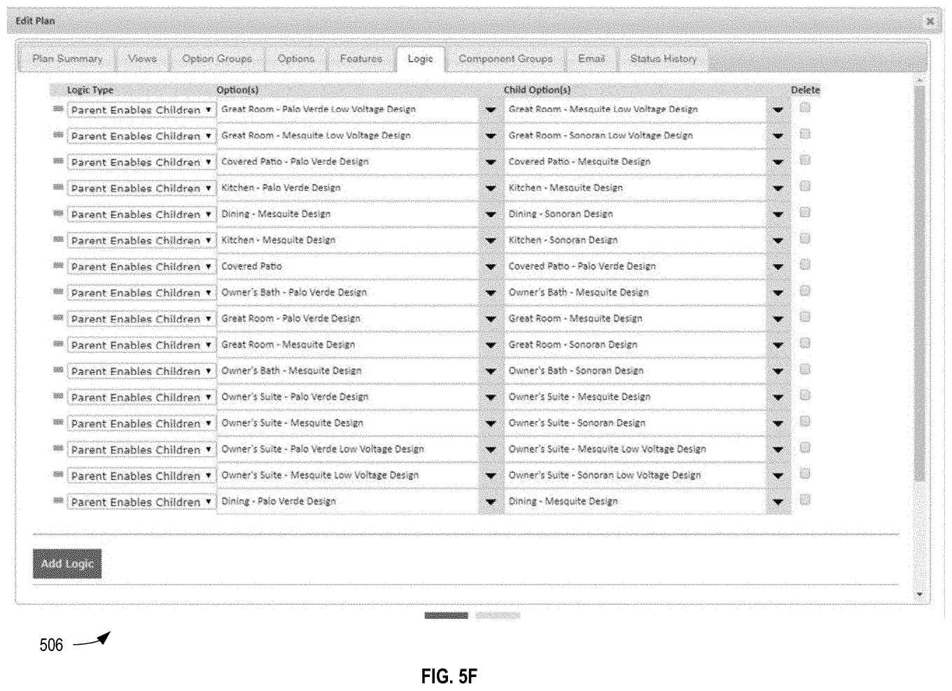

FIGS. 5A-5F, for example, illustrate components of an admin interface (e.g., 101 in FIG. 1) in accordance with one embodiment that allows a front-facing user interface to be created. Referring first to FIG. 5A, a “Features” window 501 allows the admin to specify a feature name and SVG Node. The SVG node allows for data identification within the admin system that will correlate with both the 2D plan view and the 3D graphic views of the front facing user interfaces (FIG. 3 and FIG. 4, respectively), while FIG. 5B illustrates a “View” window 502 employed by the admin to associate an SVG ID with a particular type of view (e.g., “floor” or “exterior”) and assign that view a name.

As used herein, SVG refers to a Scalable Vector Graphics layer or file, and the SVG ID refers to an arbitrary alphanumeric string that is associated with that layer or file. The invention is not limited to SVG image formats, however, and may be used in conjunction with other image formats now known or later developed. In general, the admin process may include receiving a drawing from an architect in an electronic format (e.g., AutoCAD), cleaning it up and removing extraneous items, converting the drawing to multiple layers, each having a respective SVG ID, uploading the layers to the tool, defining the logic corresponding to each layer, and linking the various parts and kits to a back-end database that provides real-time price information.

FIG. 5C illustrates an “Option Groups” window 503 that allows the admin to associate each view and SVG ID with an Option Group Type (e.g., “POIs,” “Regular,” “Exteriors”), and an assigned name. FIG. 5D illustrates, in an “edit plan” mode, an “Options” window 504 that allows the admin to specify an option name, square footage, price, builder options, SVG Node, and whether such selections are enabled. FIG. 5E illustrates a plan summary window 505 that includes basic information about the plan, such as the plan name, status (approved, not approved), community name, and other such information commonly associated with a plan. Finally, FIG. 5F illustrates a “Logic” window that allows the admin to specify a logic type (e.g., “Parent Enables Children”), options, and child options that effectively create a hierarchy of logically interrelated options.

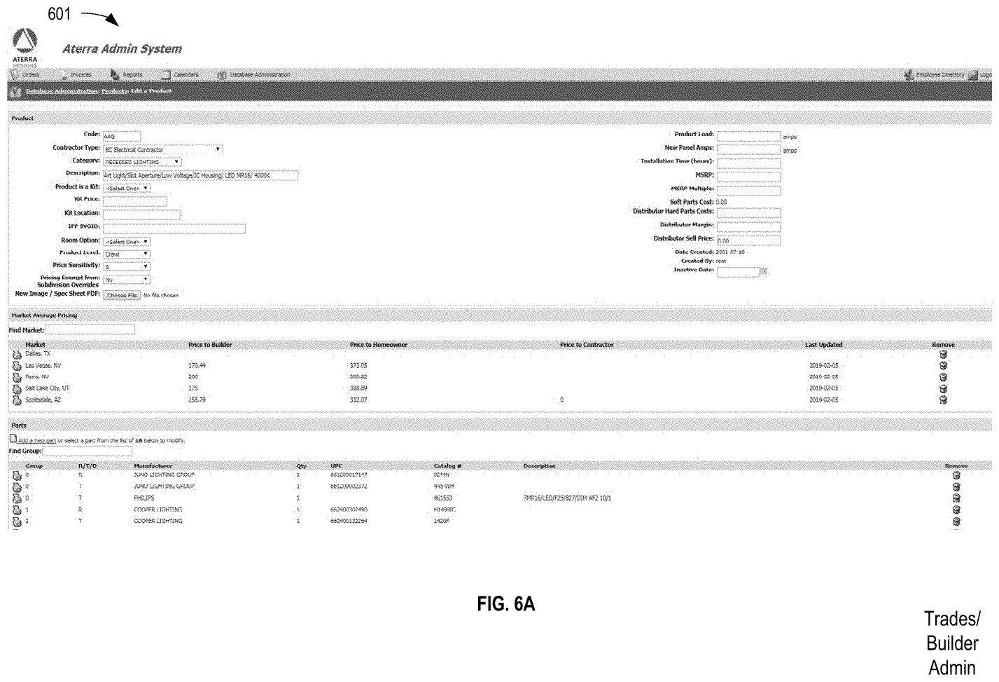

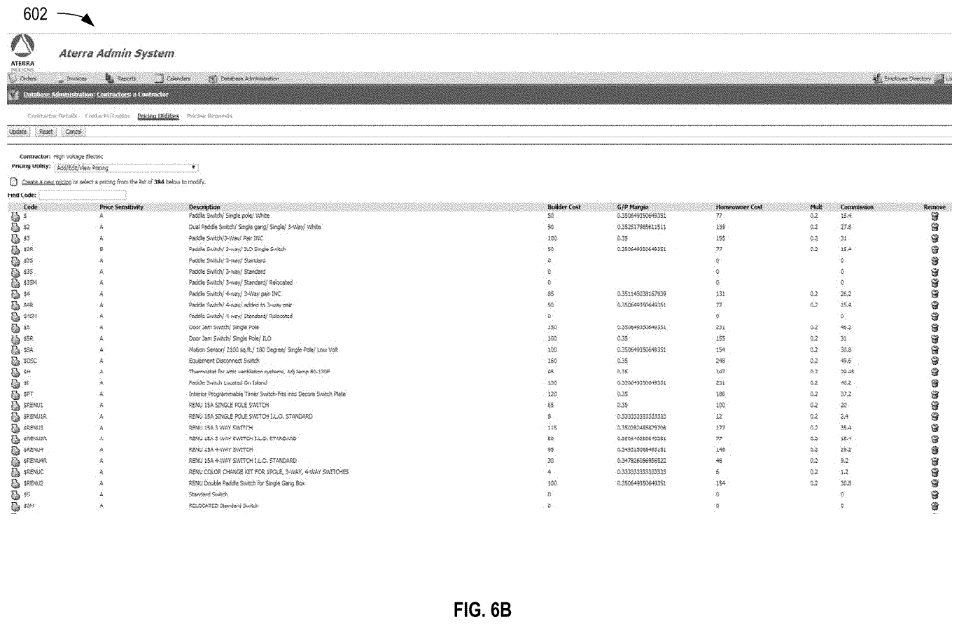

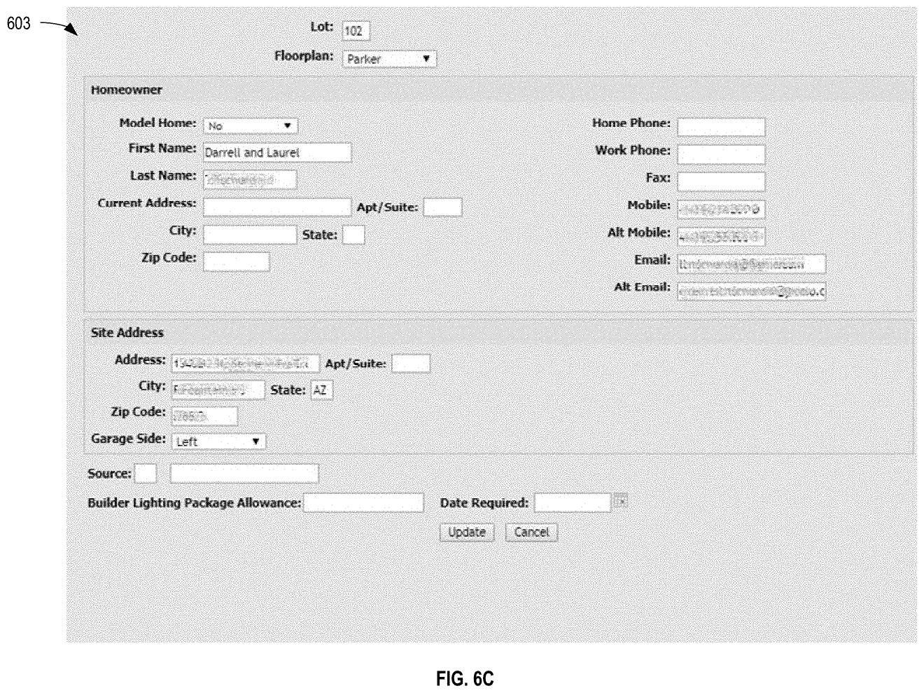

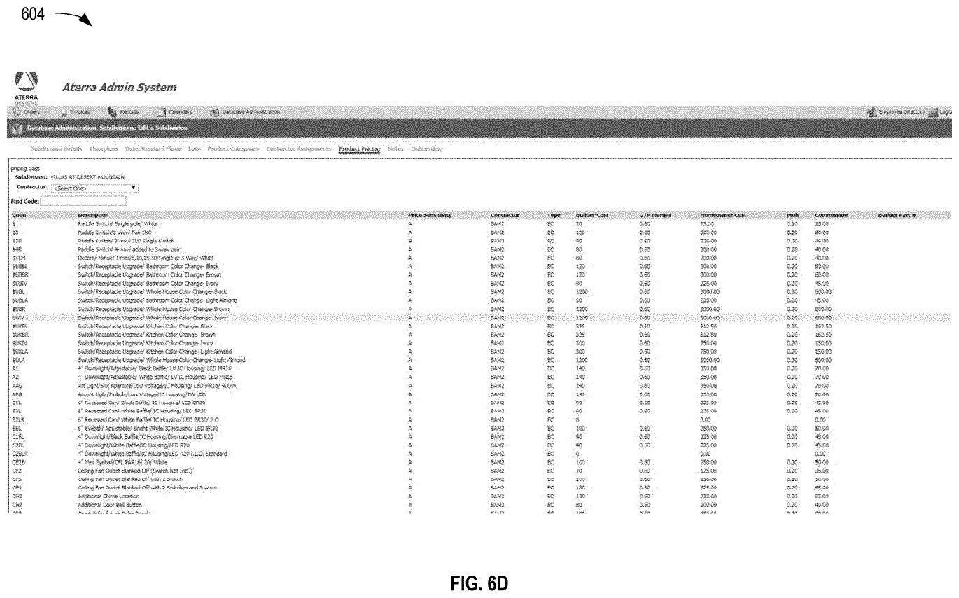

FIGS. 6A-6D illustrate various user interface components of a trades/builder admin interface in accordance with various embodiments. FIG. 6A illustrates a database administration page 601 that allows the trades/builder to edit product details, market average pricing, and part groups. The parts groups for a singular SVG Node ID allows multiple manufacturers to be used, consistent with the guidelines set forth by the builder and/or contractor, thereby creating an open architecture parts-selection process that is embedded into the tool's user interface. FIG. 6B illustrates a database contractor page 602 that allows the trade/builder to modify contractor details, pricing utilities, and pricing requests. FIG. 6C illustrates a data entry page 603 that presents a summary of a lot and floorplan in terms of the homeowners contact details and site address. FIG. 6D illustrates a subdivision-specific database page that similarly allows the admin to review/adjust the costs associated with particular parts for a specific subdivision.

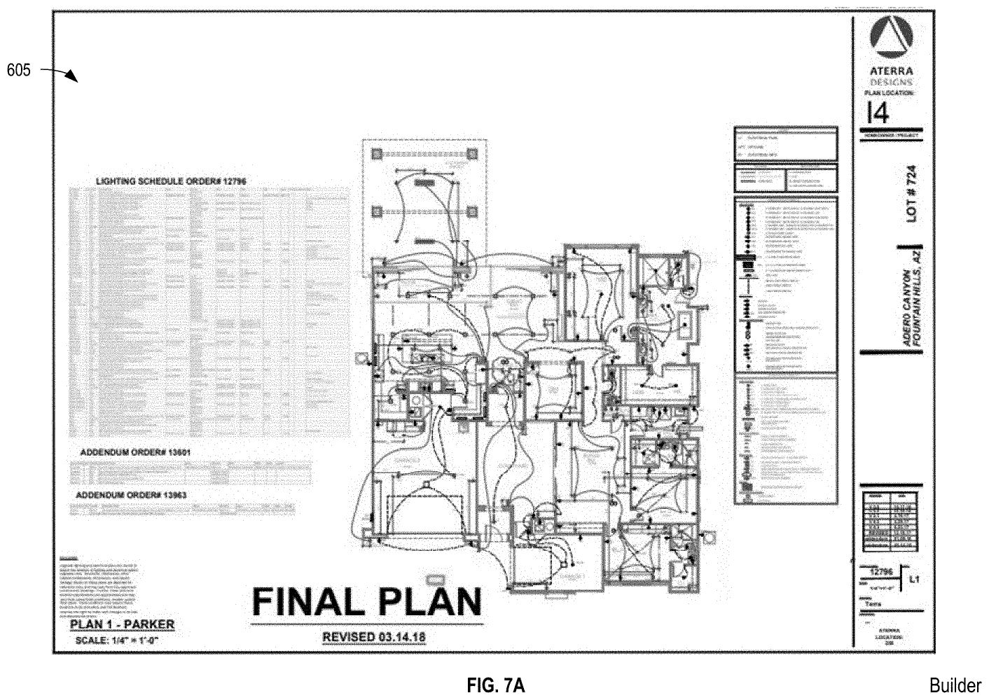

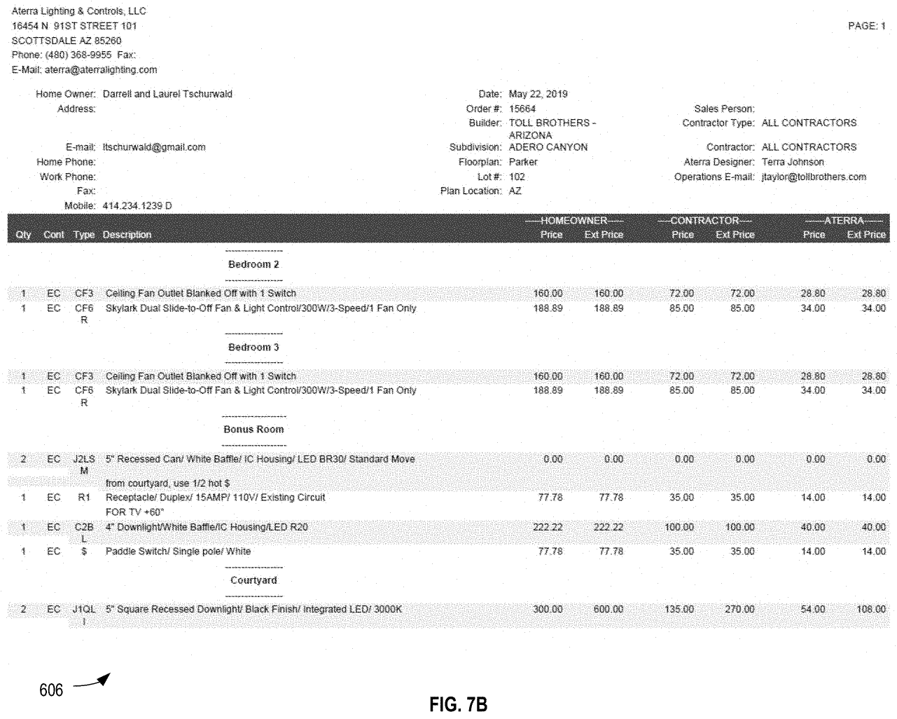

FIGS. 7A-7B illustrate various user interface components of a builder interface in accordance with various embodiments. That is, FIG. 7A illustrates a “Final Plan” 605 (e.g., 131 in FIG. 1) and FIG. 7B illustrates a trade-pricing printout corresponding to the final plan.

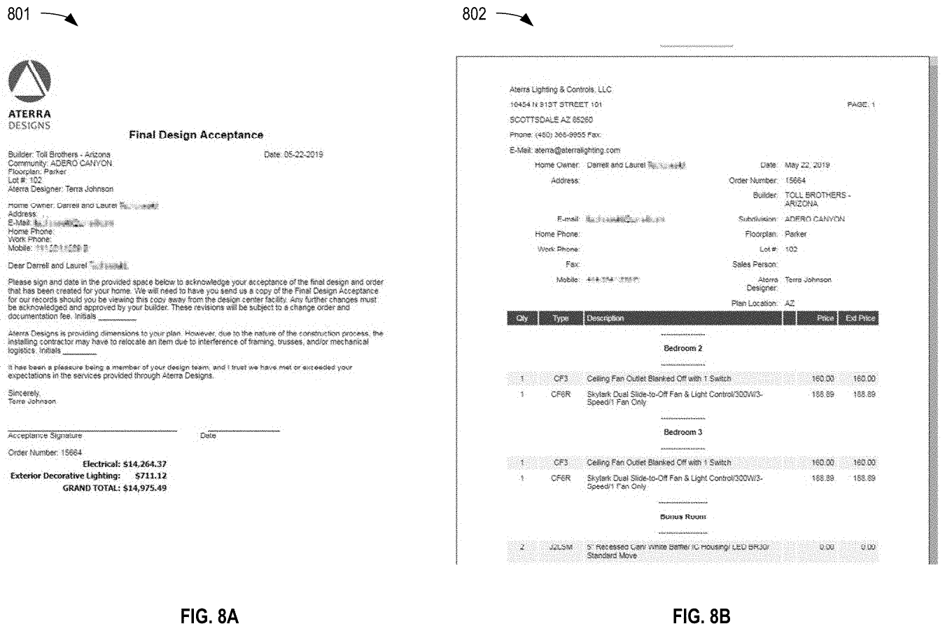

FIGS. 8A-8B illustrate various user interface components of a client/homeowner interface in accordance with various embodiments. That is, FIG. 8A illustrates an example final design acceptance letter to be executed by the homeowner, and FIG. 8B illustrates a client order (e.g., a “final order”) corresponding to the accepted design.

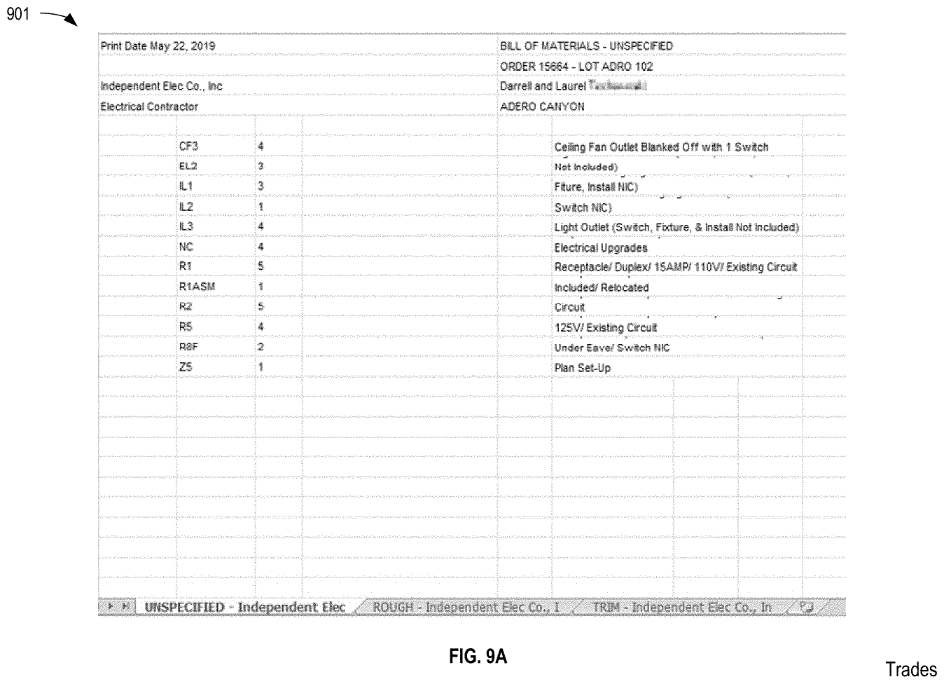

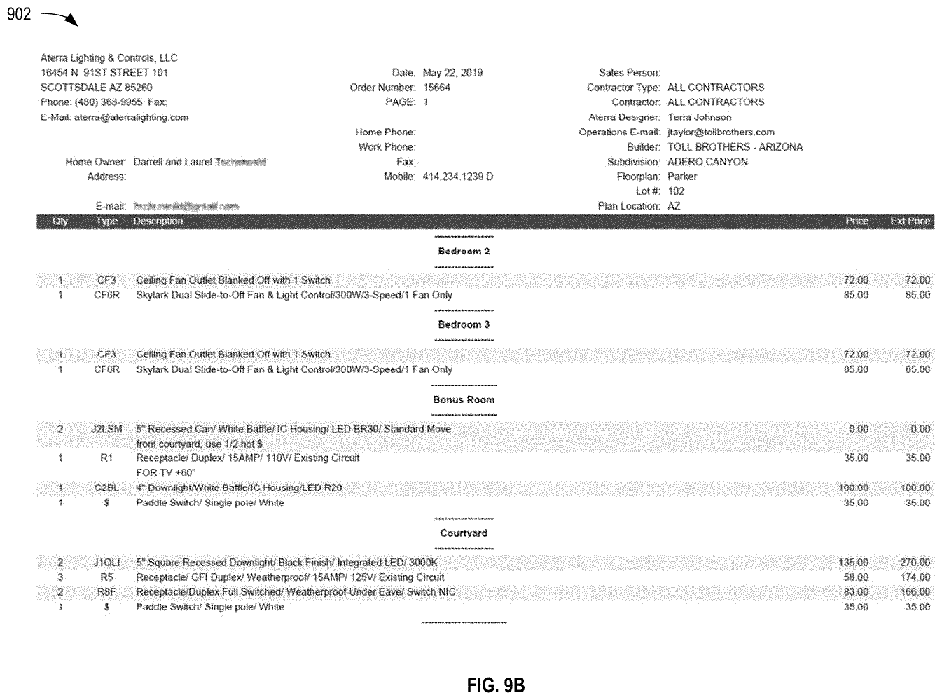

FIGS. 9A-9B illustrate various user interface components of a trades interface in accordance with various embodiments. That is, FIG. 9A illustrates an example bill of materials 901 (which may comprise a multi-paged Excel document, as shown), and FIG. 9B illustrates the final Contractor Order 902.

In summary, the foregoing describes an improved, web-based interactive design tool for lighting, electrical, and other home technology options. The interactive floorplan system is fully integrated into a supply chain, thereby allowing designers, homeowners, builders, and trades to efficiently specify electrical, lighting, and other home technology in a streamlined way that reduces both design and construction cycle times as well as field errors. Further, the interactive floorplan system allows the homeowner to visualize the home not only in a top-down 2D view, but also in a 3D virtual, interactive mode. This provides many up-sale opportunities, as the homebuyer can immediately visualize the benefits of selecting upgraded lighting options.

In summary, a virtual, interactive floorplan system includes a database system configured to store data associated with a plurality of home interior options, and a web-based portal communicatively coupled to the database system, wherein the web-based portal is configured to provide a user interface. The user interface provides: (a) an option-selection mechanism through which a user can select, for a specified home design, one or more options from the plurality of home interior options; (b) a graphical visualization of the specified home design from a 2D plan view and a 3D virtual interactive mode that together display the effect of selecting the home interior options; (c) a report generation mechanism through which the user can generate purchase orders and trade specific installation instructions in the form of at least lot-specific plans, orders, and a bill of materials.

In accordance with some embodiments, the system described herein can be integrated into a kiosk in a home builder's design center and may be operated in part by lighting sales personnel.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention. As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

1. A virtual, interactive floorplan system comprising:
A database system configured to store data associated with a plurality of home interior options;
a web-based portal communicatively coupled to the database system, the web-based portal configured to provide a user interface;
wherein the user interface provides: (a) an option-selection mechanism through which a user can select, for a specified home design, one or more options from the plurality of home interior options; (b) a graphical visualization of the specified home design from a 2D plan view and a 3D virtual interactive mode that together display the effect of selecting the home interior options; (c) a report generation mechanism through which the user can generate purchase orders and trade specific installation instructions in the form of at least lot-specific plans, orders, and a bill of materials.

2. The system of claim 1, wherein the one or more options comprises lighting options, and the 3D virtual interactive mode allows the user to observe the effect of lighting changes in the environment of the selected home based resulting from the selected options;

3. The system of claim 2, wherein the 3D virtual interactive mode allows the user to selectably turn one or more virtual lighting fixtures on and off.

4. The system of claim 3, wherein the system further includes an interface allowing the user to observe the environment of the selected home via a virtual reality or mixed reality headset.

5. The system of claim 1, wherein the database further stores a scalable vector graphics (SVG) layer including a plurality of SVG associated with locations within the 2D plan view and the 3D virtual interactive view.

6. The system of claim 1, further including an administration portal for configuring the web-based-portal and the database.

7. A method for interactive floorplan design, comprising:
storing, within a database, data associated with a plurality of home interior options;
providing a user interface for a web-based portal communicatively coupled to the database system;
presenting the user with an option-selection mechanism associated with a specified home design;
receiving, via the option-selection mechanism, one or more options from the plurality of home interior options;
displaying a graphical visualization of the specified home design from a 2D plan view and a 3D virtual interactive mode that together display the effect of selecting the home interior options; and
receiving, via a report generation mechanism, a request to generate purchase orders and trade specific installation instructions in the form of at least lot-specific plans, orders, and a bill of materials.

8. The method of claim 7, wherein the one or more options comprises lighting options, and the 3D virtual interactive mode allows the user to observe the effect of lighting changes in the environment of the selected home based resulting from the selected options;

9. The method of claim 7, wherein the 3D virtual interactive mode allows the user to selectably turn one or more virtual lighting fixtures on and off

10. The method of claim 7, wherein the system further includes an interface allowing the user to observe the environment of the selected home via a virtual reality or mixed reality headset.

11. The method of claim 7, wherein the database further stores a scalable vector graphics (SVG) layer including a plurality of SVG associated with locations within the 2D plan view and the 3D virtual interactive view.

12. The method of claim 7, further including providing an administration portal for configuring the web-based-portal and the database.

13. A virtual, interactive floorplan system comprising:
a database system configured to store data associated with a plurality of home interior options including lighting options;
a web-based portal communicatively coupled to the database system, the web-based portal configured to provide a user interface, wherein the user interface provides: (a) an option-selection mechanism through which a user can select, for a specified home design, one or more options from the plurality of home interior options; (b) a graphical visualization of the specified home design from a 2D plan view and a 3D virtual interactive mode that together display the effect of selecting the home interior options; (c) a report generation mechanism through which the user can generate purchase orders and trade specific installation instructions in the form of at least lot-specific plans, orders, and a bill of materials;
wherein the 3D virtual interactive mode allows the user to observe the effect of lighting changes in the environment of the selected home based resulting from the selected options and allows the user to selectably turn one or more virtual lighting fixtures on and off while observing the environment changes.
